(19) United States
(12) Patent Application Publication
(10) Pub. No.: US 2025/0265425 A1
(43) Pub. Date: Aug. 21, 2025

(54) ARTIFICIAL INTELLIGENCE BASED ANALYSIS OF SESSION REPLAYS

(71) Applicant: Sprig Technologies Inc., San Francisco, CA (US)

(72) Inventors: Kevin Matthew Mandich, San Francisco, CA (US); Tanner Pierce, San Francisco, CA (US); Chuheng Yu, San Jose, CA (US); Qiang Zheng, Mountain View, CA (US); Ryan James Glasgow, Orinda, CA (US); Govind Sartaj Brahmanyapura, San Francisco, CA (US)

(21) Appl. No.: 19/054,444

(22) Filed: Feb. 14, 2025

Related U.S. Application Data
(60) Provisional application No. 63/554,906, filed on Feb. 16, 2024.

(51) Int. Cl. G06F 40/40

(52) U.S. Cl. CPC G06F 40/40

(57) ABSTRACT

A system generates session replays that capture event data representing user actions performed with an online application. The system performs analysis of the session replays to display information describing the session replays. The system receives a plurality of session replays and generates a representation of each session replay. The system clusters the plurality of session replays using representations of the plurality of session replays to obtain a plurality of clusters of session replays. A cluster of session replays comprises session replays similar to other session replays of the cluster. For each cluster of session replay the system determines information characterizing the cluster of session replays. The system selects at least a subset of clusters of session replays from the plurality of clusters of session replays and sends information characterizing each cluster of session replays from the subset of clusters of session replays for display via a user interface.

### CROSS REFERENCE TO RELATED APPLICATIONS

This application claims the benefit of U.S. Provisional Application No. 63/554,906, filed Feb. 16, 2024, which is incorporated by reference in its entirety.

### BACKGROUND

This disclosure generally relates to user interactions with systems and, in particular, to artificial intelligence-based analysis of replays of user interactions with systems.

Users perform interactions with systems, for example, online systems or online applications to utilize the features offered by the systems. Online applications are designed to let users perform specific workflows. Some of the features of an online features may be designed to encourage users to perform certain actions. For example, certain widgets may be presented via the user interface to cause users to perform certain actions. However, in production, the users may not use the online application in expected ways. For example, users may get confused with certain portions of the user interface and perform unexpected user actions. As a result, features of the online application may not be utilized as expected. For example, users may be dissatisfied with the usability of certain features even though they may not have been using the application as expected. Typical user interactions with an online application may be studied during testing and development of the online application. However, the behavior of users in production may not match the behavior of the users performing testing of the application. The behavior of users in a production environment is challenging to capture.

### SUMMARY

A system generates session replays that capture event data representing user actions performed with an online application. A session replay is configured to be associated with events of a trigger event type. A display of a user interface of the online application is displayed via a client device. The system stores event data describing user actions performed via the user interface of the online application in a replay data store. The replay data store retains event data representing user actions performed within a recent time interval. The system detects an occurrence of a trigger event of the trigger event type and extracts session replay data representing user actions performed with the online application via the client device within a temporal neighborhood of the trigger event including a range of time between a specified threshold time before the trigger event and a specified threshold time after the trigger event. The session replay data is sent for display via a dashboard user interface.

According to an embodiment, the system performs analysis of the session replays to display information describing the session replays. The system receives a plurality of session replays. Each session replay represents a sequence of user interactions performed with a user interface of an online application. The system generates a representation (or data representation) of each of the plurality of session replays. The system clusters the plurality of session replays using representations of the plurality of session replays to obtain a plurality of clusters of session replays. A cluster of session replays comprises session replays determined to be similar to other session replays of the cluster of session replays. For each cluster of session replay the system determines information characterizing the cluster of session replays. The system selects at least a subset of clusters of session replays from the plurality of clusters of session replays and sends information characterizing each cluster of session replays from the subset of clusters of session replays for display via a user interface.

### BRIEF DESCRIPTION OF THE DRAWINGS

FIG. 1A is a block diagram of a system environment in which a real-time survey system operates, in accordance with an example embodiment.

FIG. 1B is a screenshot of a dashboard 125 that allows a user to view session replays captured by the system according to an embodiment.

FIG. 2 is a block diagram showing the architecture of a real-time survey system, in accordance with an example embodiment.

FIG. 3 is a block diagram of an administration module of a real-time survey system, in accordance with an example embodiment.

FIG. 4 is a block diagram of a response processing module of a real-time survey system, in accordance with an example embodiment.

FIG. 5 shows an example user interface for displaying real-time survey content to a user of the application, in accordance with an example embodiment.

FIG. 6 is a flowchart illustrating an example process for selecting, displaying, and analyzing a real-time survey displayed to a user via a user device, according to an embodiment.

FIG. 7 illustrates the system architecture of a session replay analysis module, according to an embodiment.

FIG. 8 shows a flowchart illustrating the process of generating clusters of session replays according to an embodiment.

FIG. 9 shows a flowchart illustrating the process of generating descriptions of clusters of session replays according to an embodiment.

FIG. 10 shows a flowchart illustrating the process of generating a representative session replay for a cluster of session replays according to an embodiment.

FIG. 11 shows a screenshot of a user interface illustrating session replay data received by the system according to an embodiment.

FIG. 12 shows a screenshot of a user interface illustrating clusters of session replays presented by the system according to an embodiment.

The figures depict various embodiments for purposes of illustration only. The figures use like reference numerals to identify like elements. One skilled in the art will readily recognize from the following discussion that alternative embodiments of the structures and methods illustrated herein may be employed without departing from the principles described herein.

### DETAILED DESCRIPTION

A system generates session replays that capture event data representing user actions performed with an online application. The system receives an indication that session replays are enabled for an online application. A session replay is configured to be associated with events of a trigger event type. A display of a user interface of the online application is displayed via a client device. The system repeatedly stores event data describing user actions performed via the user interface of the online application in a replay data store. The replay data store retains event data representing user actions performed within a recent time interval. The system detects an occurrence of a trigger event of the trigger event type. Responsive to detecting the occurrence of the trigger event of the trigger event type, the system extracts session replay data representing user actions performed with the online application via the client device within a temporal neighborhood of the trigger event including a range of time between a specified threshold time before the trigger event and a specified threshold time after the trigger event. The session replay data is sent for display via a dashboard user interface.

According to an embodiment, the trigger event is associated with an online survey associated with the online application. For example, the trigger event may trigger the online survey and the session replay data comprises user actions associated with the online survey including user actions performed within the threshold time before the trigger event.

According to an embodiment, the system deletes event data representing user actions that are older than the threshold time compared to a current time.

The features and advantages described in this summary and the following detailed description are not all-inclusive. Many additional features and advantages will be apparent to one of ordinary skill in the art in view of the drawings, specification, and claims hereof.

### System Architecture

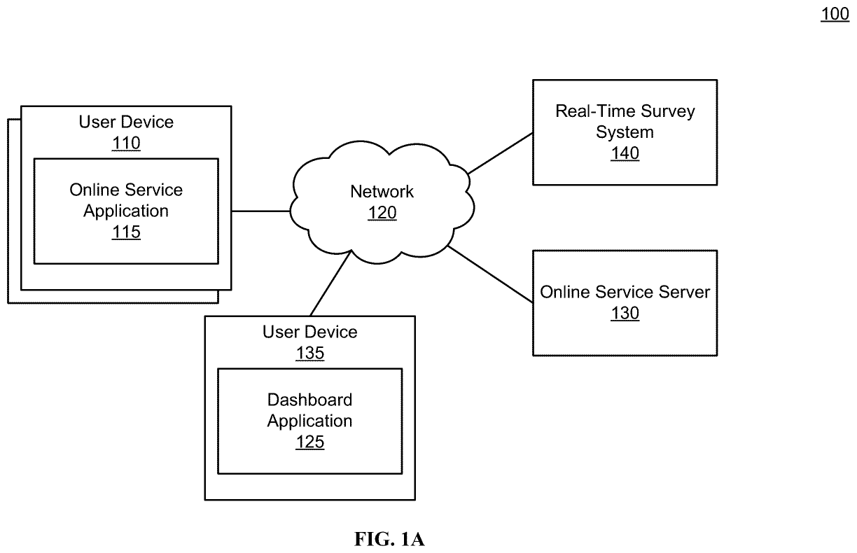

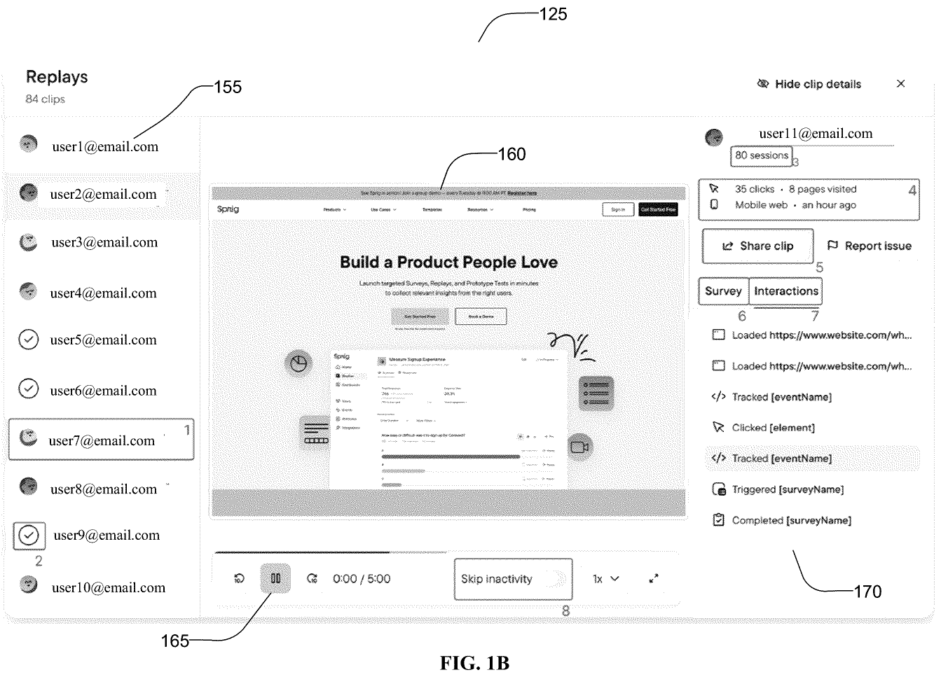

FIG. 1A is a block diagram of a system environment in which a real-time survey system operates, in accordance with an example embodiment. The environment 100 of FIG. 1 includes a set of user devices 110 running an online service application 115, a network 120, an online service server 130 associated with the application 115, and a real-time survey system 140. In other embodiments, the environment 100 may include additional, fewer, or different entities. For example, only one online service application 115 and online service server 130 is shown in environment 100, but other implementations can include multiple applications 115, each associated with one more online service servers 130. Similarly, the online service server 130 and the real-time survey system 140 are shown as separate entities, but in some embodiments, the real-time survey system may be integrated within the online service server 130. The online service application may also be referred to herein as an online application.

Each user device 110 includes one or more computing devices capable of displaying content to users, receiving user input, and transmitting and/or receiving data via the network 120. A user device 110 can include conventional computing systems, such as desktop or laptop computer, personal digital assistants (PDA), mobile phones, smartphones, smartwatches, wearable devices, or other suitable devices. Each user device 110 can be configured to communicate with the online service server 130 or real-time survey system 140 via the network 120. In some implementations, user devices 110 execute an online service application 115 associated with an online service server 130. A user device may also be referred to herein as a client device or a device.

The online service application 115 can allow a user of the user device 110 to interact with the online service server 130 and/or real-time survey system to view content, provide user input, and/or view and respond to real-time surveys based on their activities within the online service application 115. For example, the online service application 115 can be a browser application enabling interaction between the user device 110 and the online service server 130 via the network 120. In other cases, user devices 110 interact with the online service server 130 through an application programming interface (API) running on a native operating system of the user device 110. In some implementations, the online service application 115 is affiliated with the online service server 130, for example, the online service application 115 and online service server 130 can be created and managed by the same entity.

An online service application 115 can record and store event data about the user's actions as the user interacts with the online service application 115. In some implementations, this data is later sent to the real-time survey system 140 for aggregation and analysis of survey results. In some embodiments, the online service application 115 displays real-time survey content to users via a user interface (UI) or UI element appearing in addition to the standard application UI for interacting with the online service server 130.

In some embodiments the online service application 115 can be configured to enable a session replay. A session replay allows a user, for example, a system administrator to replay user interactions performed by a user with the online service application 115. A session replay may also be referred to herein as a replay. For example, the user interactions may be displayed as a video displaying the user interactions performed by the user with the online service application 115 during the time interval via a dashboard 125 running on a user device 135. The session replay may be triggered by certain events. The configuration of the online service application 115 may specify the type of events or the conditions that trigger the online service application 115 to save information for allowing the session replay.

The session replay data may be played via a dashboard at a later stage or immediately after the record time interval is finished. The configuration may specify the session replay duration in terms of a predefined number of time units, for example, seconds or minutes. A session replay may be associated with a survey or may be a standalone survey that is not associated with a survey. The replay of the session allows a user, for example, a system administrator to review information associated with an event or a survey. For example, if a user indicates in the survey triggered by an event, that the user is not satisfied with certain feature, the session replay of the time interval during which user performed the survey as well as the interactions performed before and after the survey allow a system administrator to determine what may have caused the user to be dissatisfied. Alternatively, if a new feature is released via the online service application 115, the session replay may allow a system administrator or an analyst to determine whether users are struggling while using the feature.

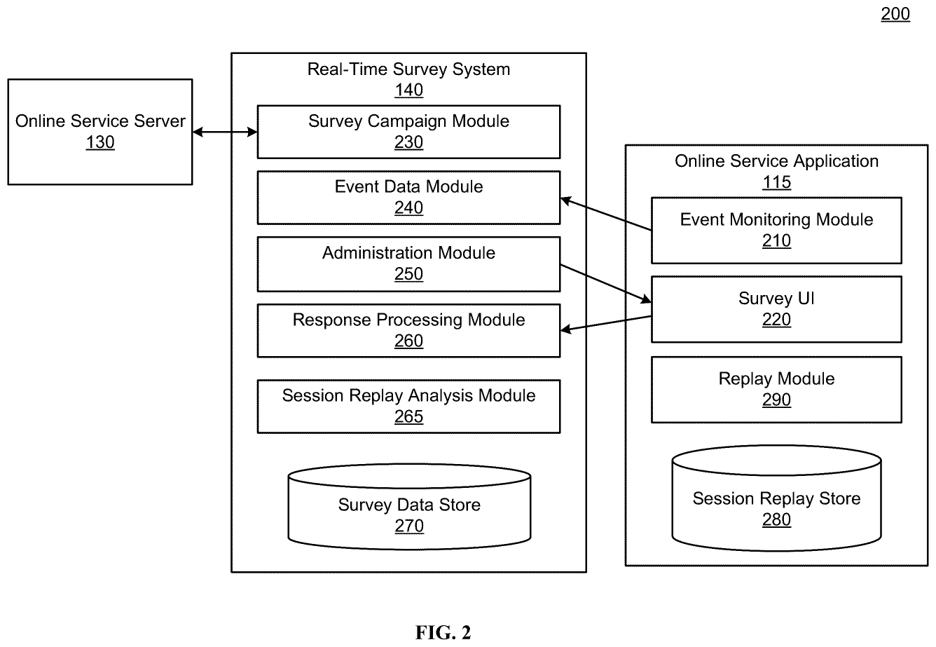

The session replay may allow an analyst to review the user interactions and determine whether a particular aspect of the user interface associated with the feature is confusing the users. For example, if the feature may cause a widget to display via a user interface requesting the users interact with the widget. However, if at that stage of the feature, the user ends up interacting with other portions of the user interface, an analyst may determine that the user interface needs to be redesigned since the user interface is not clearly conveying to the user, the particular user interaction expected from the user at that particular stage of the feature. The session replay feature allows system administrator or analyst to perform such analysis. The online service application will be discussed further in relation to FIG. 2.

In some implementations, the user devices 110, online service server 130, and real-time survey system 140 are configured to communicate with each other via the network 120. The network 120 can comprise any combination of local area and/or wide area networks and both wired and/or wireless communication systems. The network 120 can use standard communications technologies and/or protocols such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, some or all communication links of the network 120 are encrypted or otherwise secured using any suitable technique or techniques.

The online service server 130, according to some embodiments, includes a set of servers or other computing systems capable of controlling and delivering content to users via the online service application 115, managing user interaction with the online service application 115, and/or providing a service to users of the online service application 115. The online service server can include conventional computing systems, such as server computers, server clusters, cloud storage or computing capability, or other suitable systems. The online service server 130 can be configured to communicate with user devices 110 or the real-time survey system 140 via the network 120.

Depending on the implementation, the online service application 115 can provide many different types of service to users. For example, the online service server can provide content (for example user-created, entertainment, artistic, or editorial content), allow for ecommerce, or allow users to play games, among many other potential features that could be provided by the online service server 130. In some cases, the administrators of the online service server 130 seek to improve the user experience of users of the online service application 115 or gain a better understanding of how users are using the online service application 115 through surveying users through the real-time survey system 140. The real-time survey system 140 can be an outside vendor or otherwise separate from the online service server 130 or, as described above, can be integrated within the online service server 130.

In some embodiments, the real-time survey system 140 (also referred to as the RTSS 140) is a set of servers or other computing systems capable of managing and executing one or more survey campaigns gathering data from users of an online service application 115. The RTSS 140 can include conventional computing systems, such as server computers, server clusters, cloud storage or computing capability, or other suitable systems. The RTSS 140 can be configured to communicate with user devices 110, 135 or the online service server 130 via the network 120.

As used herein, a survey is an individual set of questions that can be sent to one or more users as part of a survey campaign. Some implementations and examples are described herein in the context of “microsurveys” or short surveys often containing two or less questions, though these techniques can also be implemented with longer formats of survey. A survey campaign (as administered by the RTSS 140) includes a process of generating and sending surveys to multiple users to and analyzing the received results to determine a result of the survey campaign. In some implementations, the RTSS 140 can dynamically assign surveys to users for many different simultaneous survey campaigns. Because the same user may be eligible for many different surveys assigning users is not trivial and may require selection between multiple campaigns a given user is eligible for. In some embodiments, the RTSS 140 can automatically analyze user responses to survey questions (including difficult to interpret freeform questions). The RTSS 140 can interface with the online service application 115 running on a user device 110 to display survey content to a user of the device 110.

FIG. 1B is a screenshot of a dashboard 125 that allows a user to view session replays captured by the system according to an embodiment. The dashboard is also referred to herein as the dashboard application or the dashboard user interface. The session replay data from various user devices 110 running instances of online service application 115 may be stored in a storage that is accessible to the dashboard 125 running on the user device 135. For example, the session replay data may be stored in a cloud storage. The various session replays may be indexed by identifiers of users that were interacting with the online service application 115 when the session replay was captured. The dashboard 125 shows user identifiers 155, for example, emails 155 of the user associated with the user device 110 running the online service application 115 that caused the session replay to be generated. The system administrator interacting with the dashboard 125 can select an email 155 to see the session replays associated with the email. The dashboard 160 displays the session replay, for example, as a video 150. The dashboard 160 allows the system administrator to interact with the session replay using various widgets 165 that cause the session replay to perform various operations such as pause, play, rewind, forward, change speed of play, skip inactivity in the session replay, and so on. The dashboard 125 also displays metadata 170 describing the session replay. For example, if the session replay is associated with a survey, the metadata may describe the survey such as name, status (whether completed or not). The metadata may describe the event that triggered the session replay or the event that triggered the survey associated with the session replay.

FIG. 2 is a block diagram showing the architecture of a real-time survey system, in accordance with an example embodiment. The RTSS 140 shown in FIG. 2 includes a survey campaign module 230, event data module 240, administration module 250, response processing module 260, a replay analysis module 265, a survey data store 270, and a session replay store 280. The RTSS 140 is in communication with the online service server 130 and an online service application 115, which includes an event monitoring module 210 and survey UI 220. In other embodiments, the RTSS 140 and online service application 115 can include additional, fewer, or different components for various applications. Conventional components such as network interfaces, security functions, load balancers, failover servers, management and network operations consoles, and the like are not shown so as to not obscure the details of the system architecture.

The online service application 115 shown in FIG. 2 includes an event monitoring module 210 which can gather data about users' actions as they interact with the online service application 115.

Event data gathered by the event monitoring module 210 can include an identifier of the event, an identifier of the user and/or user device 110, a timestamp of the event, and/or other properties of the event. In some embodiments, the event monitoring module 210 sends collected event data to the RTSS 140 for use in selecting surveys for that user. Event data can be collected, processed, and sent by the event monitoring module 210 in real-time or near real-time such that the RTSS 140 can send relevant surveys in a timely manner.

For example, the event monitoring module 210 can collect event data when a user clicks on links within the online service application 115, view or interacts with content through the application 115, uses one or more features of the application 115, or generally interacts with the application 115 in a measurable way. In some implementations, the event monitoring module 210 can collect data on “programmatic events” tracking action that users take within the application 115, such as logins, cart checkouts, or completed transactions. Similarly, the event monitoring module 210 can monitor “URL events” triggered when a user visits a specific page or type of page within the application 115 (for example, a page with a URL matching a predetermined pattern). Additionally, “interaction events” triggered when a user interacts with a specific element of a UI (such as a button, menu, or text field) can be monitored. Not all events or event types may be monitored for each application 115, depending on the type and features of the application 115 and the requirements of survey campaigns being run by the RTSS 140.

The replay module 290 determines and stores information for performing session replays. According to an embodiment, the replay module 290 captures events and stores them in the session replay store 280 on an ongoing basis. The replay module 290 determines whether an event has triggered a session replay. If the session replay is triggered, the replay module 290 retains the event data stored for a past time interval of the length configured for the session replay. If no events trigger a session replay for more than a threshold time, the replay module 290 may delete event data for older events.

The session replay store 280 stores information describing various session replays, for example, event data describing events that occurred in a time interval associated with session replay. According to an embodiment, the information describing a session replay describes the various events that occurred during the time interval of the session replay. The session replay store 280 may associate each session replay with a user identifier of the user of the device that caused the session replay to be triggered. The data related to a session replay may be moved to another system, for example, the RTSS 140 or to a cloud storage for access by a dashboard 125.

The survey UI 220 of the online service application 115 can, in some implementations, receive survey content from the RTSS 140 and display the survey to the user through a user interface allowing the user to respond to survey questions. After collecting the user's responses, the survey UI transmits the gathered responses to the RTSS 140 for aggregation and analysis. Each survey response sent by the survey UI 220 can include an identifier of the survey the user was shown, the content of the user's response(s), which can include freeform text answers, multiple choice selections, and other types of responses, a timestamp of the response, and (in some implementations), an identifier of the user providing the response.

In some embodiments, by embedding the survey content within the online service application 115 itself, use of the RTSS 140 reduces the computational load on the user device 110, which otherwise would have to use a separate email application or generate a new browser window (potentially requiring opening a separate application browser application). Instead, directly including the survey within the survey UI 220 improves the responsiveness of the user device 110 in displaying surveys (for example reducing the time between receiving a survey and actually having survey content displayed to the user) and can improve the user experience for a user receiving a survey.

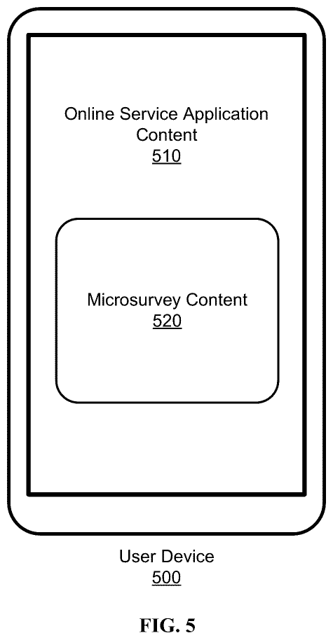

The survey UI can be displayed as a pop-up over an existing UI of the online service application 115, be presented in its own UI screen, or be presented to a user in another suitable fashion. In some implementations, survey content can be received by the survey UI 220, which can wait until a later time to administer the survey. For example, the survey UI 220 may wait until a user is finished entering payment details or the like before disrupting the user with a survey. A simple example survey UI is shown in FIG. 5.

In some implementations, the RTSS 140 selects and administers surveys for one or more survey campaigns based on event data and user attributes about users of an online service application 115. As described above, events represent data about discrete actions or conditions met by a user at a certain point in time. Attributes, as used herein, are pieces of descriptive information about users, such as persistent characteristics or demographics. In some implementations, events may be automatically detected and forwarded to the RTSS 140. Similarly, attributes can be directly provided by users based on information provided by the user at sign-up for the service (or at another explicit opt-in point), received directly from an online service application 115, or provided by the online service server 130 in the form of a user attribute file, public API, or database access. For example, when users may provide email, product plan, and geographic location/address attributes when they create a paid account with the online service application.

In some embodiments, the survey campaign module 230 sets up and maintains survey campaigns for one or more online services 130. The survey campaign module 230 can communicate with the online service server 130 to determine parameters for various survey campaigns. For example, a survey campaign can include one or more surveys, each with different questions and different prerequisites for being shown to users (herein, “survey constraints”). For example, survey constraints can select for users who triggered a certain event within a threshold time or users associated with a given event a threshold amount of times. A survey campaign can also have other properties such as a resurvey rate controlling how often the same user can be surveyed (for that campaign or for any survey sent by the RTSS 140) and a desired response rate or target sample size for collecting data. Once a survey campaign is set up and activated, the RTSS 140 can begin monitoring event data and sending surveys to users for that survey campaign.

A survey campaign can also be associated with one or more parameters of the survey campaign itself, for example if the survey campaign is a fixed or continuous survey campaign. In a fixed campaign, the exact amount of responses they would like to receive (i.e. the sample size of the survey) is defined at campaign creation. The RTSS 140 can then serve surveys until the desired sample size is reached before ending the survey and returning analyzed results. A continuous campaign can instead run for an extended period of time, with a desired number of responses per day defined at campaign creation. For continuous surveys, the RTSS 140 can serve surveys throughout the day until the daily response threshold is reached and then wait until the next day to collect more responses. If the threshold is not achieved for a specified day, the system will attempt to “catch up” in the future by collecting more than the daily response threshold.

For example, if an ecommerce online service 130 would like to gather information from customers in Brazil via a survey sent at the moment of checkout, the survey campaign could be configured to use geographical location attributes (provided by the service 130) for each user and monitored programmatic events tracking when a user completes the checkout process to trigger a survey. Once the campaign is activated, the RTSS 140 would serve surveys to and collect responses from Brazilian users who had just completed checkout.

The event data module 240, according to some embodiments, collects and stores received attribute data and event data collected by the online service applications 115. In some implementations, the event data module 240 stores the received data in the survey data store 270. Surveys can include constraints based on historical event data or previously provided attributes, for example a survey could be sent to users who previously used a feature, but haven't recently, or the like. Once collected and logged by the event data module 240, the event and attribute data is ready to be used by the RTSS 140. In some implementations, the event data module 240 collects and stores data in real-time to facilitate real-time triggering of surveys for users based on currently occurring actions.

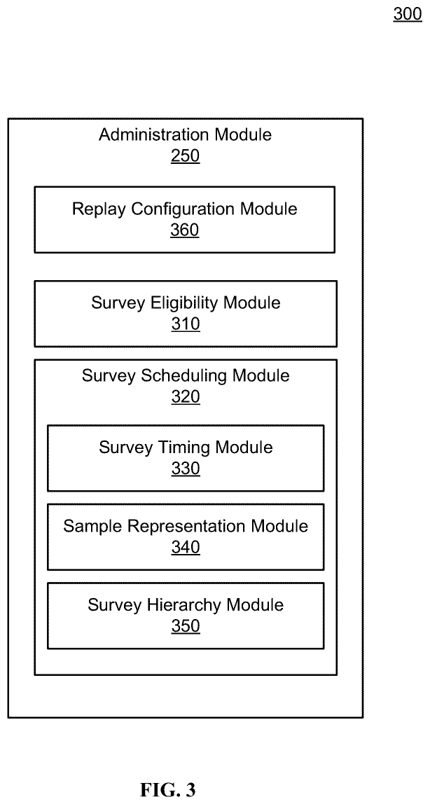

The administration module 250 allows users to configure replays. For example, the user may create and specify details of a standalone replay or a replay associated with a survey. In some implementations the administration module 250 selects and administers surveys to users for survey campaigns based on collected event and attribute data. In some embodiments, administering surveys is a multistep process. In the filtering stage the administration module 250 can determine which users are eligible to receive a survey using both events and attributes. Then the administration module 250 can trigger the actual sending of the survey by determining when a survey is shown to an eligible visitor using event data. The administration module 250 will be discussed further in relation to FIG. 3.

The response processing module 260 receives and analyzes survey responses from administered surveys. In some embodiments, the response processing module 260 uses machine learning techniques and NLP (natural language processing) to automatically analyze survey data. After analysis, the response processing module 260 may send analysis results to the online service server 130 if appropriate. The response processing module 260 may also monitor the overall number of responses for a given survey campaign and determine if enough data has been collected or surveying should continue (based on the properties of that specific campaign).

The replay analysis module 265 performs analysis of the data gathered via session replays. For example, the replay analysis module 265 may use machine learning techniques to analyze session replays. After analysis, the replay analysis module 265 may send analysis results to the online service server 130 if appropriate. The replay analysis module 265 may perform the analysis of sessions replays on demand based on a request by a user, for example, a system administrator. Alternately, the replay analysis module 265 may automatically perform analysis of the session replays to determine if any anomalous behavior is observed and sends an alert, for example, a message to a system administrator if an anomalous behavior is identified based on the analysis of the replay.

The survey data store 270 includes one or more databases, cloud storage solutions, or the like used to store survey campaign details, user attributes, collected event data, and user survey responses. The survey data store 270 can be implemented using any suitable technology and may be local to the RTSS 140, remotely connected via the network 120, or the like.

### Survey and Replay Administration

FIG. 3 is a block diagram of an administration module of a real-time survey system, in accordance with an example embodiment. The administration module 250 shown in FIG. 3 includes a replay configuration module 360, a survey eligibility module 310, and a survey scheduling module 320. The survey scheduling module 320 of FIG. 3 includes a survey timing module 330, a sample representation module 340, and a survey hierarchy module 350. In other embodiments, the administration module 250 includes additional, fewer, or different components for various applications.

The replay configuration module 360 configures replays for an online service application 115. The replay may be configured to be associated with a survey, for example, a ne survey or an existing survey. A replay may be created as a standalone survey. For a standalone replay, the relay configuration specifies details of a type of event that triggers the replay. A replay associated with a survey is also associated with the event that triggers the survey. Accordingly, each survey is associated with a trigger event. A replay associated with a survey can be played from a user interface displaying information for the survey. The replay configuration may specify a length of time for which the replay is captured. The length of time for which the replay is captured includes a period of time before the event that triggers the replay. For example, the replay may be configured to capture at least 2 minutes of user interactions with the online service application 115 before an event that triggers the replay occurs. Examples of events that trigger a replay or a survey associated with a replay include a particular type of user interaction, for example, a user clicking on a link, a user clicking on a particular widget (e.g., a submit button), and so on. Other examples of events that trigger a replay or a survey associated with a replay include a particular type of action performed by the online service application 115, for example, sending a message, configuring and causing a particular user interface to be displayed, running particular query, executing a particular set of instructions (e.g., a function or method), and so on. According to an embodiment, the system groups replays together for each survey that specified the trigger event that triggered the replays. For example, if trigger T1 specifies a trigger event E1 that generates a set of replays and trigger T2 specifies a trigger event E2 that generates another set of replays, the system groups the replays in to two groups, one corresponding to the trigger T1 and another corresponding to trigger T2.

According to an embodiment, the system implements an “always-on replay” strategy that allows the system to capture event data on a continuous basis without requiring event triggers. Accordingly, the replays can be captured independent of the user action that was performed. Since always-on replays may not be associated with a trigger, the always-on replays are grouped based on other factors associated with the replays. According to an embodiment, the system identifies various attributes of replays such as the URLs (uniform resource locators) and other signals of user behavior within the replay. For example, if a user goes through a checkout flow that includes URLs such as/cart, /checkout, /payment, and so on, the system groups a set of replays that include the same URLs into a “Checkout” replay group. Accordingly, the system performs custom grouping of always-on replays based on attributes of the replays such as URLs, user behavior patterns, and so on.

In some implementations, the survey eligibility module 310 can determine which survey campaigns and/or surveys a user is eligible to receive. As described above, each survey and/or survey campaign can be associated with a series of survey constraints which a user has to meet in order to be eligible to receive that survey. A survey constraint can be a filtering constraint (based on one or more attributes or events associated with the user) or a trigger constraint (based on a recently received event). The survey constraints for each survey can be set up with the survey campaign. In some embodiments, the survey timing module 330 evaluates a user for survey eligibility each time one or more events occur, for example, on session start or when new event or attribute data becomes available for the user.

For example, a filtering constraint can determine user eligibility using attributes based on a user having an attribute of a certain range, or part of a desired set of values, for example if the user is a part of one or more given demographic groups (such as an age group) or if a user's on-file address is within a specified geographic area. Similarly, filtering constraints can use historical event data, determining eligibility based on if the user is (or is not) associated with a specified event within a specified timeframe. Event filtering constraints can count recent event occurrences, time since the event was first recorded for the user, time since the event was last recorded for the user, or if the user has ever triggered the specified event. For example, an event-based filtering constraint can check if a user has logged in (a programmatic event) more than X times within the last week to determine eligibility for a survey aimed at frequent users of the online service application 115.

Similarly, trigger constraints can depend on event data received by the RTSS 140, but instead of relying on stored historical event data, trigger constraints can depend on recent event data (for example, event data from a user's current session using the online service application 115). For example, trigger constraints can select users who have recently performed a specified action within the online service application 115 (based on receiving a programmatic event, such as a logins, cart checkouts, or completed transactions), visits a certain part of the online service application 115 (using URL events, as described above), or interacts with a specific part of a the application UI (through receiving an interaction events for the user). In some implementations, the trigger constraint(s) for a survey can ensure the real-time relevance of the survey to actions the user has just taken (or are currently in the process of taking) as they interact with the online service application. Using trigger constraints as described can lead to higher quality survey responses (as the user still remembers the experience in question) as well as the ability to target surveys to smaller or less prominent interactions the user is unlikely to remember after the fact.

In some implementations, the survey timing module 330 also checks the resurvey rate constraint to prevent users from being spammed by surveys. As described above, the resurvey rate of a survey can be expressed as a minimum number of days between surveys. If a user is within the resurvey window, the survey timing module 330 can determine that the user is ineligible to receive further surveys until outside the resurvey window. In some implementations, the resurvey rate is one survey every 30 days (although the specific resurvey rate can depend on the implementation or be based on the survey campaign).

Each user can be simultaneously eligible for multiple surveys associated with multiple different survey campaigns and the survey timing module 330 can separately evaluate eligibility for each currently active survey campaign. At this point, the administration module 250 can identify that user that is eligible to receive the survey, but not when or if that user should be sent a survey.

In some implementations, the survey scheduling module 320 determines if and when a survey should be shown to an eligible user. The survey scheduling module 320 can mitigate or eliminate result bias that could occur due to uneven sampling of users. According to some embodiments, the survey scheduling module 320 collects survey responses over time, to ensure that all users of the online service application 115 have a more equal chance of being selected (and not unintentionally favoring users in certain time zones or who use the application 115 at certain times of day). Similarly, the survey scheduling module 320 can regulate response collection across one or more user attributes (such as user demographics, customer type, etc.) to ensure a representative sample.

For example, a survey campaign can be set up with a fixed sample size of desired responses (per-day or in total), after which response collection is halted. Exceeding the fixed sample size is undesirable, leading to excess costs and unnecessary disruption of users' experiences with surveys, so the survey scheduling module 320 can aim to send out surveys at a relatively constant rate over a few days to get a representative sample of users in the set of responses.

The survey timing module 330 of FIG. 3 can, in some implementations, determine when eligible users should be sent surveys. In some embodiments, each survey or survey campaign is associated with one or more parameters influencing the timing of the survey. Survey timing parameters can be individual timing parameters (affecting when a specific user is sent a survey within their session of using the online service application 115) or campaign-wide timing parameters (controlling the overall rate of survey collection for that survey/campaign over time).

In some implementations, individual timing parameters include a session timing parameter represented as a number of seconds or range of time after the start of a session when the user can be sent the survey. Additionally, a survey can also be associated with event timing parameters associated with certain events. For example, an event timing parameter can specify a range of time after a certain event (in some cases the event triggering the survey) the survey should be sent.

Campaign-level timing parameters, in some embodiments, regulate the overall response collection rate of the survey campaign. In some implementations, campaign timing parameters are set to achieve a roughly target rate of responses per day. For example, a survey campaign can use a sampling rate setting a fixed percentage of eligible users (such as 5% or 10%) to be sent surveys. In some implementations, the sampling rate is set based on the desired sample size and/or desired responses per day and the estimated number of eligible users each day.

In some embodiments, the survey timing module 330 uses a leaky bucket algorithm to regulate the sampling rate of a survey campaign. A leaky bucket algorithm can regulate both the average survey rate and the maximum number of simultaneous surveys sent out at once for a survey campaign. When using a leaky bucket algorithm, each campaign is associated with a “bucket” (a buffer of a predefined size). The bucket is filled by a predetermined amount whenever a survey for the survey campaign is sent and empties (“leaks”) at a fixed rate over time. If the bucket is too full to fit a new survey, that campaign is treated as inactive and no further surveys are sent until the buffer empties enough (at the fixed rate) for new surveys to be sent out without exceeding the capacity of the bucket. By varying the size of the bucket and the rate at which it empties, the survey scheduling module 320 can control the maximum rate surveys are sent out (by controlling the rate the bucket empties) and the maximum number of surveys that can be sent out at once (by setting the size of the bucket).

In some implementations, the survey timing model 330 uses a cross-leaky bucket algorithm to determine which survey to send out of a set of survey campaigns the user is eligible for. In a cross-leaky bucket algorithm, the survey timing model 330 simultaneously evaluates the leaky bucket buffer for each eligible campaign and selects a single survey based on the amount/percentage of space left in the buffer (and/or other suitable factors).

In some implementations, the survey scheduling module 320 can schedule a survey to be sent at a future time when the timing parameters are met. Then the survey scheduling module 320 can hold the survey and send it to the user's online service application 115 at the scheduled time. For example, the survey timing module 330 can determine to send a survey to a user based on recently received event data but the survey scheduling module 320 waits to actually transmit the survey to the online service application 115 until the scheduled time are met a few seconds or minutes later (when the timing constraints are met).

The sample representation module 340, in some implementations, can ensure that each survey campaign surveys a representative sample of the total population of users. The sample representation module 340 can calculate the current sampling rate across one or more user attributes (or other characteristics) and compare that to target sampling rates representing a balanced sample. For example, the sample representation module 340 can pause or reduce the rate of collection of survey data for over-sampled groups. In other implementations, the sample representation module 340 assigns a weight to each eligible user measuring the extent that user would contribute to over-sampling or help with under-sampling if surveyed. The survey hierarchy module 340 can then use the generated weights to prioritize which survey the eligible user is sent. Implementing sample representation logic as described can reduce the total number of surveys that need to be sent out to receive a representative sample of responses, saving computing resources (and user annoyance) that may be used to run additional surveys.

In many situations, a user will only be eligible for one active survey (which the survey scheduling module 320 can then send to the user), however, a given user may be eligible for multiple surveys simultaneously in some cases. The survey eligibility process can be first performed in parallel for each separate survey campaign, therefore if multiple survey campaigns are running simultaneously for the same online service application 115 a user may be eligible to be sent multiple surveys. If a user is eligible for multiple surveys, the survey hierarchy module 350 can determine which survey should be sent to the user. As described above, the survey timing module 330 can also use a cross-leaky bucket algorithm to select among multiple potential surveys.

In some implementations, the survey hierarchy module 350 ranks the potential surveys based on the current sample breakdown for each survey (for example, assigning a score based on how needed that user is for a representational sample for that survey or using weights generated by the survey hierarchy module 350). Alternatively, the survey hierarchy module 350 can select a survey randomly or semi-randomly or select a survey based on a predetermined hierarchy. In some implementations, the survey hierarchy module 350 selects between surveys using an estimated eligible user rate for each campaign (prioritizing surveys with more restrictive survey constraints that less users meet on average).

In some implementations, after a survey is scheduled to be sent to an eligible user the survey scheduling module 320 stores an event indicating that the survey was sent. Similarly, the leaky bucket for the survey can be updated to reflect the survey being sent and the user's resurvey window can be reset. Then, the survey administration module can send the survey data to the user's online service application 115 for display. For example, the survey data can include an identifier of the survey and survey content containing one or more questions for the user to answer.

### Automatic Replay Analysis

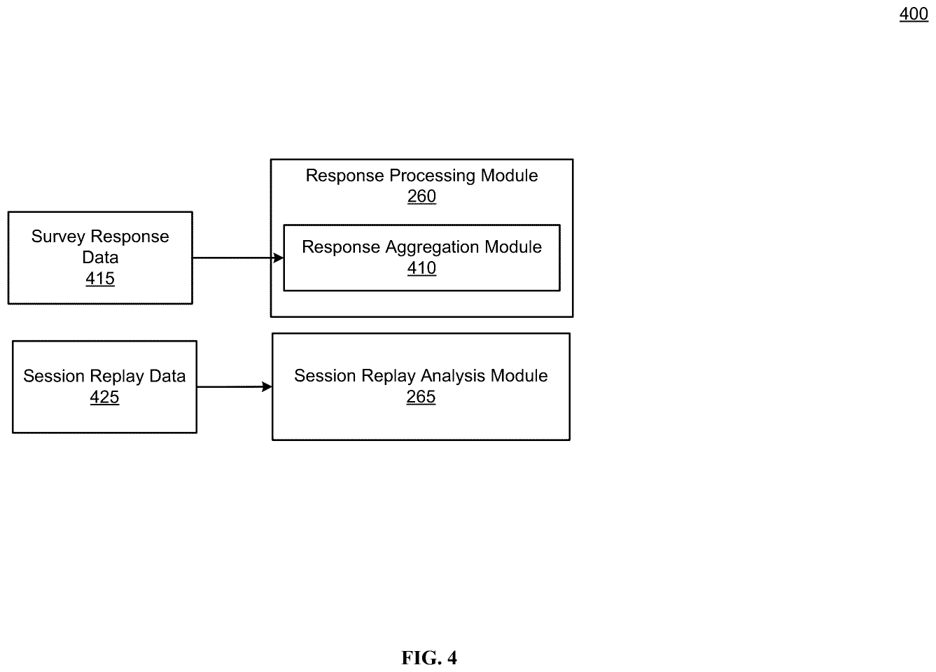

FIG. 4 is a block diagram of a response processing module of a real-time survey system, in accordance with an example embodiment. The response processing module 260 shown in FIG. 4 includes a response aggregation module 410 which collects survey response data 415 and a theme identification model 420 which is a machine learning model trained on topic/intent training data 430 (with topic/intent labels 435) used to analyze the aggregated responses. In other embodiments, the response processing module 260 includes additional, fewer, or different components for various applications.

In some implementations, the response aggregation module 410 receives and organizes survey response data 415 sent by online service applications 115. Each received survey response 415 can include an indication of the survey/survey campaign the results are in response to, a set of one or more question responses provided by the user taking the survey, and, in some embodiments, an identifier of the associated user/user device 110. After receiving a survey response, the response aggregation module 410 can validate and store the survey response in the survey data store 270 for further analysis. In some implementations, the response aggregation module 410 further preprocesses the received data, for example by anonymizing received survey responses 415 by replacing a user identification with generic attribute/event tags (for example for later demographic analysis).

In some embodiments, the response session replay analysis module 265 receives and organizes session replay data 425 received from online service applications 115. The session replay data 425 can include event data captured during a time interval associated with the session replay, information describing a survey that may be associated with the session replay, an identifier of the associated user/user device 110, and so on.

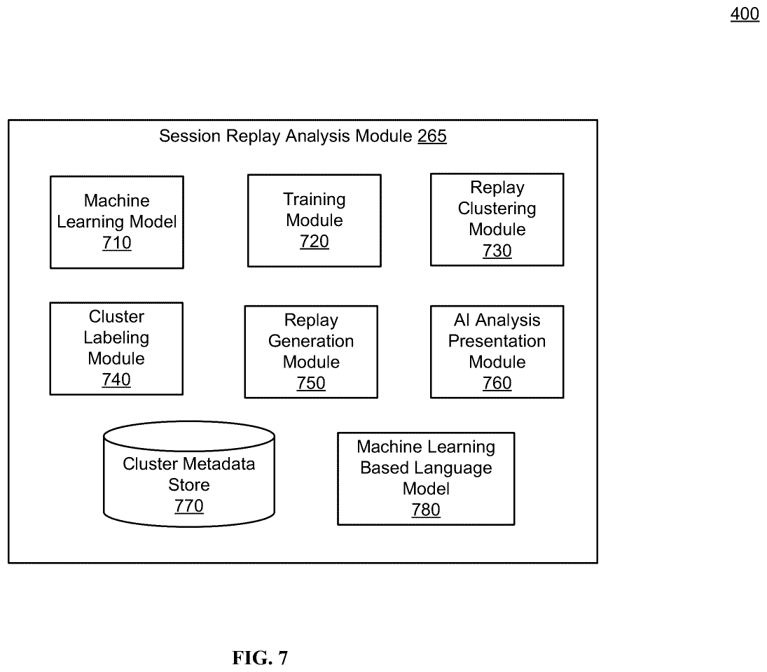

According to an embodiment, the response processing module 260 can perform machine learning based analysis of survey responses. Similarly, the session replay analysis module 265 analyzes the session replay data using machine learning models. The system architecture of a session replay analysis module 265 is illustrated in FIG. 7 and further described in connection with FIG. 7.

### Example Survey UI

FIG. 5 shows an example user interface for displaying real-time survey content to a user of the application, in accordance with an example embodiment. The user device 500 of FIG. 5 includes online service application content 510 overlaid with microsurvey content 520.

The online service application content 510 can include any content or UI elements used for a user to interact with the online service and/or online service server 130. For example, online service application content 510 can encompass ecommerce functionality (such as a checkout or cart UI), content viewing (such as an article reader or video player), video games, or the like.

In some implementations, the survey UI 220 can show survey content (such as microsurvey content 520) by modifying an interface of the online service application 115 to include the received survey content for display. The microsurvey content 520 can include one or more interactive graphical elements that, upon interaction by a user, allow the users to review survey questions and provide answers. For example, a predetermined choice question can be associated with a series of selectable answers while a freeform text question can allow users to enter their answer into a text box. After completion of the microsurvey by the user, the survey UI 220 is configured to modify the interface of the application to remove the survey content 520 such that the user can return to interacting with the online service application content 510.

The microsurvey (or any survey) may be configured to be associated with a session replay. Accordingly, when the microsurvey is triggered by an event, the session replay data corresponding to the microsurvey is made available for display via the dashboard 125.

### Real-Time Survey Processes

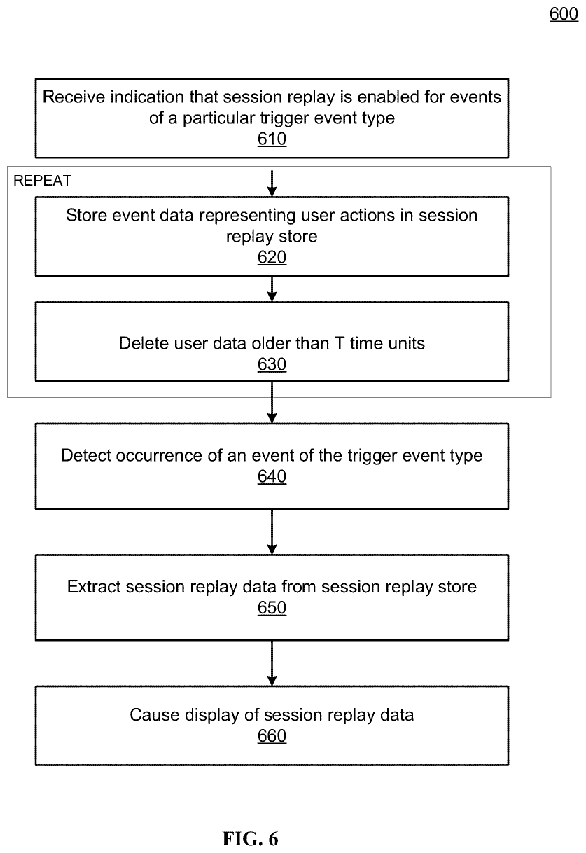

FIG. 6 is a flowchart illustrating an example process for selecting, displaying, and analyzing a real-time survey displayed to a user via a user device, according to an embodiment. The steps of the process may be performed in an order different from that indicated in FIG. 6. For example, certain steps may be performed in parallel. The steps are indicated as being performed by the online service application and may be performed by a module of the online service application, for example, the replay module 290.

The online service application receives 610 an indication that session replay is enabled. The indication may be provided by a user, for example, a system administrator by configuring the application. A session replay may be configured to be triggered by events of a trigger event type. For example, certain types of user interaction may trigger generation of a session replay. This causes the online service application to obtain session replay data relevant to the trigger event. The session replay data captures user interactions associated with the trigger event including user interactions performed before the trigger event and/or user interactions performed after the trigger event.

According to an embodiment, the session replay is configured to be associated with a survey. Accordingly, the session replay data may include one or more of (1) user interactions performed before the event that triggered the survey, for example, user interactions performed within a threshold time of the trigger event and before the trigger event occurred (2) user interactions performed during the survey, and (3) user interactions performed after the survey.

The online service application may display a user interface via a client device. The user interface allows the user of the client device to interact with the online service application. The user interface may also cause the survey to be displayed to the user if the session replay is associated with a survey.

The repeatedly stores 620 in the session replay store 280, event data describing user actions performed via the client device with the online service application. The stored event data retains user actions performed at least for a threshold time interval, for example, a time interval of length T time units. For example, the online service application may delete 630 event data corresponding to user actions that are older that the threshold time, i.e., older than T time units.

The online service application detects an occurrence of a trigger event of the trigger event type. For example, if the trigger event type represents a particular type of user interaction, the online service application detects occurrence of that type of user interaction. Responsive to detecting the occurrence of the trigger event of the trigger event type, the online service application extracts from the session replay store 280, session replay data representing user actions performed with the online service application via the client device within a temporal neighborhood of the trigger event including a range of time between a specified threshold time before the trigger event and a specified threshold time after the trigger event. The session replay data may be displayed via a user interface of a dashboard application.

According to an embodiment, the session replay data is an array of event objects, wherein an event object represents a user interaction. The representation of an event may comprise a serialized representation of a DOM (document object model) representing the user interface of the online service application. The representation of an event may comprise a difference between the DOM representation after the user action compared to the DOM representation before the user action. The various DOM representations allow a system, for example, the dashboard to recreate the user interactions with the online service application.

According to an embodiment, the session replay data is modified before presentation on a dashboard. For example, the online service application may display user information that is sensitive, for example, social security number or any PII (personally identifiable information) of the user. The system modifies the session replay data to mask such information. For example, the system may traverse the DOM representation corresponding to an event in the session replay data, identify the sensitive data, and replace the sensitive data with masked information. For example, fields such as password may be blurred or replaced with generic characters such as stars.

According to an embodiment, the session replay data is compressed for storing in the session replay store or for transmitting the session replay data via a network.

### Artificial Intelligence Based Replay Analysis

According to various embodiments system receives multiple session replays and performs analysis of the session replays using artificial intelligence techniques to provide users with insights based on the session replays. If a large number of session replays are obtained for a particular feature, users have to manually review the session replays to analyze them. The number of session replays received for a feature of an online system depends on the number of users that were exposed to the feature of the online system, for example, via a user interface such as a website. Accordingly, for large deployments several thousand or hundreds of thousand session replays may be received. Analysis of such large number of session replays is challenging. For example, it may not be possible for a single user to review all the session replays. If multiple users review the session replays it may be difficult to combine the information collected by different reviewers and valuable insight based on the entire set of replays may be lost.

To overcome these difficulties, the system according to various embodiments, uses artificial intelligence techniques to help with analysis of the session replays. The system surfaces details/information about clips or groups of clips without requiring users to watch each clip. The system summarizes clusters of clips with a text description. The system summarizes all clips on aggregate by a reconstruction of what the average user took, e.g., generate a single replay clip. The system identifies permutations of user paths through an event and provides ability to drill into specific flows/events of interest. The system groups session replays to allow for easy selection by users. The system selects clips that are most important for users to watch, tags clips with properties that allow a user to better decide which clips to watch and surfaces common user behaviors (like rage clicks or dead clicks) within a replays table.

### System Architecture

FIG. 7 illustrates the system architecture of a session replay analysis module, according to an embodiment. The session replay analysis module 265 comprises a machine learning model 710, a training module 720, a replay clustering module 730, a cluster labeling module 740, a replay generation module 750, an AI analysis presentation module 760, cluster metadata store 770, and a machine learning based language model 780. Other embodiments of session replay analysis module 265 may include more or fewer modules than indicated in FIG. 7.

The machine learning model 710 is trained by the training module 720 and is configured to receive as input a representation of a session replay and output certain prediction for the input session replay. The machine learning model 710 may be generated based on a set of training data, for example, labelled data that may be generated by experts. For example, the machine learning model may be trained by the training module 720 to predict a score indicating a type of user experience for the input session replay.

The replay clustering module 730 receives a set of session replays and clusters them into a plurality of clusters based on their properties. Generating clusters of session replays helps users analyze the session replays. For example, the user may select a particular cluster for inspection based on their properties. A cluster of session replays may also be referred to herein as a group of session replays.

The information describing the clusters may be stored in the cluster metadata store 770. The information stored in the cluster metadata store 770 may include a membership mapping indicating the session replays that belong to the cluster, features describing the cluster, a label describing the cluster.

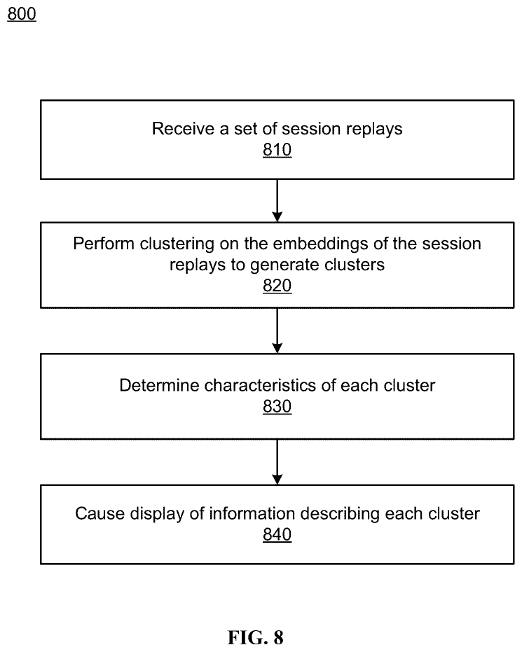

The cluster labeling module 740 generates a label for each cluster based on properties of the cluster. According to an embodiment, the cluster labeling module 740 executes the process illustrated in FIG. 8 and described in connection with FIG. 8 for generating labels for clusters. The labels generated for clusters are stored in the cluster metadata store 770. According to an embodiment, the cluster labeling module 740 determines a title, a description, and a number of associated session replays for each cluster. A default cluster represents inactive users indicating that the user performed minimal user interactions during the session and was mostly inactive during the session.

The replay generation module 750 generates a session replay that is representative of a cluster. For example, if a cluster represents session replays having a particular feature, the replay generation module 750 generates a session replay having typical values of the feature based on the members of the cluster.

The AI analysis presentation module 760 configures a user interface for presenting the analysis of the replay analysis module 265. For example, the AI analysis presentation module 760 may display the various clusters generated by the replay clustering module 730 along with the labels for each cluster generated by the cluster labeling module 740. The AI analysis presentation module 760 may also allow the user to perform replay of the representative session replay for the cluster generated by the replay generation module 750.

According to an embodiment, the machine learning model 710 is training using training data set that includes a number of session replays and their scores as determined by experts, for example, based on explicit feedback provided by users. The training dataset may include several session replay examples that represent expected user interactions (positive training samples) as well as session replay examples that represent unexpected user responses (negative training samples). According to an embodiment, the training module 720 initializes the parameters of the machine learning model 710, for example, using random values within a predetermined range and uses a technique such as gradient descent to adjust the parameter values. For example, the training module 720 runs the machine learning model 710 to make a prediction based on various session replays of the training dataset and determines a loss indicating a measure of difference between a predicted output and the actual output of the labelled training data. The training module 720 adjusts the parameters of the machine learning model 710 to minimize the loss value.

Depending on the embodiment, the machine learning model 710 may be based on any machine learning technique, for example, supervised learning (using training data labeled to include correct output values), unsupervised learning (using unlabeled training data), reinforcement learning, deep learning or neural network algorithms, active learning, and other suitable techniques or algorithms. For example, the machine learning model 710 may be a neural network, for example, a multilayered perceptron.

According to an embodiment, a machine learning model is trained based on session replay data to determine whether a session replay includes user interactions that deviate from an expected behavior. The machine learning model may be trained to predict a score indicating whether the session replay represents an expected user interaction or an unexpected user interaction. For example, an output score above a threshold value may indicate that the user interaction in the session replay represents an unexpected behavior. The session replay analysis module 265 may send a notification to a user, for example, a system administrator identifying a session replay that needs further analysis.

According to an embodiment, machine learning model 710 is trained to determine whether a particular event in a sequence of events within a session replay represents anomalous interaction by the user. Accordingly, the machine learning model is executed for multiple events within the session replay to identify a subset of events representing an anomalous user interaction.

According to an embodiment, the machine learning model 710 receives an encoding of various features of a session replay. The features of a session replay may include a representation of the user interface with which the user interacted during the session, for example, a DOM (document object model) tree. The features of a session replay may include a sequence of events that occurred during the session, each event representing a type of user interaction, the portion of the DOM tree with which the interaction was performed, and length of time intervals between interactions.

The features of a session may include number of clicks in the session, total replay time, events that occurred immediately prior to the event trigger that triggered the session replay or immediately after the event trigger, other events triggered that are associated with the session, pages visited by the user immediately before the event trigger, pages visited by the user immediately after the event trigger, time spent by the user on each page, mouse behavior including how the mouse travelled between user actions, time spent by user scrolling on a page, various key board inputs on a page, a number of sessions, and so on. The features of session may include information describing the user that performed the session, for example, user attributes including the industry that the user belongs to, a customer segment characterizing the user, a flag indicating whether the user is a power user or not, and so on.

According to an embodiment, the machine learning based language model 780 is configured as a transformer neural network architecture. Specifically, the transformer model is coupled to receive sequential data tokenized into a sequence of input tokens and generates a sequence of output tokens depending on the inference task to be performed. The machine learning based language model 780 is trained to perform natural language processing (NLP) tasks include, but are not limited to, text generation, query processing, machine translation, chatbot applications, and the like. Although a transformer-based model is described as an example language model, other embodiments may use language models using other architectures and the techniques disclosed are not limited to a particular language model architecture.

The machine learning based language model 780 may be a large language model (LLM) that is trained on a large corpus of training data to generate outputs for the NLP tasks. An LLM may be trained on massive amounts of text data, often involving billions of words or text units. The large amount of training data from various data sources allows the LLM to generate outputs for many inference tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units (GPUs) for training or deploying deep neural network models. In one instance, the LLM may be trained and hosted on a cloud infrastructure service. The LLM may be trained by the online concierge system 140 or entities/systems different from the online concierge system 140. An LLM may be trained on a large amount of data from various data sources. For example, the data sources include websites, articles, posts on the web, and the like. From this massive amount of data coupled with the computing power of LLMs, the LLM is able to perform various inference tasks and synthesize and formulate output responses based on information extracted from the training data.

In one embodiment, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

According to an embodiment, the machine learning based language model 780 is executed by a different server and provided as a service that is invoked by executing the APIs (application programming interfaces) of the service. For example, the online system may generate a prompt and send to the service using an API of the service. The online system receives a response from the service and extracts the required information from the response.

While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like. The LLM is configured to receive a prompt and generate a response to the prompt. The prompt may include a task request and additional contextual information that is useful for responding to the query. The LLM infers the response to the query from the knowledge that the LLM was trained on and/or from the contextual information included in the prompt.

According to an embodiment, the system may derive various types of outputs based on replay session data such as images corresponding to screenshots of replay sessions, video representing the entire session replay or a clip of the session replay, a textual description of the session replay and so on. The derived output in various formats can be used for performing downstream tasks. For example the system may process raw event data to create screenshots, and may use combinations of screenshots and raw event data in tandem to create summaries of session replays.

According to an embodiment, the machine learning based language model 780 is a multi-modal language model that can receive inputs in various format described herein including text, video, images, audio, or various combinations and process them. Accordingly, the system may provide screenshots of the session replays along with textual description of session replays in a prompt to the machine learning based language model 780 with instructions to generate summaries of session replays. In general, the system provides input data of any format and in any combination of formats to the machine learning based language model 780 to process session replays and generate outputs such as summaries or insights based on the input data.

### Processes

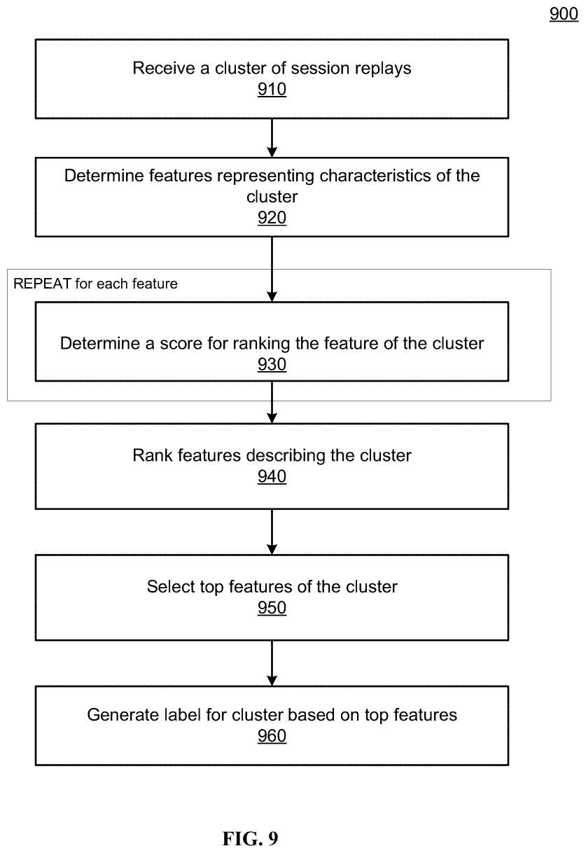

FIG. 8 shows a flowchart illustrating the process of generating clusters of session replays according to an embodiment. The steps of the process illustrated in FIG. 9 may be performed by various modules of the replay analysis module 265 for example, the replay clustering module 730.

The replay clustering module 730 receives 810 a set of session replays and clusters them into a plurality of clusters based on properties of session replays such that session replays having the same property are included in the same cluster. For example, a cluster may include all sessions in which the user performed a particular user interaction that was not expected.

The replay clustering module 730 uses the embeddings of a set of session replays to perform 820 clustering, for example, using k-means clustering techniques. The replay clustering module 730 generates a plurality of clusters based on the clustering. The replay clustering module 730 may perform further analysis of the clusters to determine 830 characteristics of each cluster, for example, a title, a description, and so on. Other types of information characterizing a cluster of session replays include: (1) High-level topical tags used to filter and sort clusters. (2) Examples of entire clips and key moments in individual clips that showcase the topic or takeaway of the cluster. (3) Statistics describing events or user interactions of session replays, for example, average session time; average number of clicks and other interactions; frustration signals such as dead clicks, for example, user clicking repeatedly without getting any response; error occurrences, for example, high occurrences of particular type of error responses during user interactions in sessions; rage interactions, for example, user typing random strings of text or clicking repeatedly or rapidly without moving cursor.

The replay clustering module 730 stores the information characterizing the cluster in the cluster metadata store 770. The AI analysis presentation module 760 causes 840 display of information characterizing each cluster. According to an embodiment, the replay clustering module 730 selects a subset of the clusters for displaying via a user interface, for example, a dashboard. The subset of the clusters may be selected by ranking the clusters based on the characteristic features of the cluster. For example, a cluster representing a significant user interface issue causing the users to become frustrated with the user interface may be ranked higher than a user interface feature that causes slight delay in the workflow compared to an expected session time.

The clustering of the replay sessions may be performed using different techniques according to various embodiments. The data representation of a session replay generated by the replay clustering module 730 may be one or more of the following. (1) The text representation of the raw event stream input of the session replay. (2) A derived text summary of the session replay, which may be generated by the machine learning based language model 780. (3) A derived human-readable list of important events of the session replay, which may be generated by the machine learning based language model 780. (4) Embedding of the text representation of raw event stream input, which may be generated by the machine learning based language model 780. (5) Embedding of the derived text summary of the session replay, which may be generated by the machine learning based language model 780. (6) Embedding of the derived human-readable list, which may be generated by the machine learning based language model 780. (7) One or more images generated by recreating the application webpage from a saved DOM snapshot of the session replay. (8) One or more videos generated by recreating the application webpage from a saved DOM snapshot of the session replay.

A data representation of the session replay is generated by the machine learning based language model 780 by performing the following steps: (1) generating a prompt comprising information describing the session replay and instructions to generate a particular data representation, (2) sending the prompt to the machine learning based language model 780 for execution, (3) receiving a response generated by executing the machine learning based language model 780; (4) extracting the data representation from the response.

According to an embodiment, the replay clustering module 730 may generate a vector embedding based on the session replay and performs clustering of the session replays based on vector distances between vector embedding representations of the plurality of session replays.

According to an embodiment, the replay clustering module 730 generates a prompt for machine learning based language model 780. The prompt comprises a text representation of the session replay. The replay clustering module 730 provides the prompt to the machine learning based language model and receives a response by executing the machine learning based language model. The replay clustering module 730 extracts the vector embedding from a response received from the machine learning based language model.

According to an embodiment, replay clustering module 730 executes the machine learning model 710 to generate vector embeddings of session replay. A vector embedding may also be referred to herein as an embedding. According to an embodiment, the machine learning model 710 is a multi-layered neural network that is executed using various session replays to generate an embedding of each session replay. The replay clustering module 730 repeats following steps for each session replay. The replay clustering module 730 generates an encoding of the session based on features describing the session and provides the encoding to the machine learning model 710 as input. The replay clustering module 730 executes the machine learning model 710 to generate a vector embedding based on the session replay. The vector embedding of a session replay may be extracted from a hidden layer of the neural network, for example, the last layer of the neural network that is used to generate the output. The vector embedding of a session replay is a vector representation that is compact and has fewer dimensions than the input representation of the session replay. The vector embeddings of session replays may be compared with each other, for example, using a distance metric or based on a cosine similarity of the two vector embeddings to determine whether two vector embeddings are similar to each other. For example, two vector embeddings are determined to be similar to each other if the vector distance between the two vector embeddings is less than a threshold value. Alternatively, two vector embeddings are determined to be similar to each other if the cosine similarity metric determines based on the two vector embeddings is less than a threshold value. The vector embeddings of the replay sessions are clustered using a clustering technique such as k-means clustering.

According to an embodiment, the replay clustering module 730 generates textual representations of session replays. The textual representation may describe a raw event stream input, for example, a sequence of events that form the session replay, each event described in text format. The replay clustering module 730 may generate a vector embedding based on the textual representation of a session replay. For example, the replay clustering module 730 generates a prompt for a machine learning based language model, the prompt comprising a text representation of the session replay and provides the prompt to the machine learning based language model. The replay clustering module 730 extracts the vector embedding from a response received from the machine learning based language model.

According to an embodiment, the replay clustering module 730 generates text describing each user interaction of the sequence of user interactions of the session replay. The replay clustering module 730 generates a summary of the session replay based on the text describing the user interactions. According to an embodiment, the replay clustering module 730 extracts a summary of the session replay from a response generated by the machine learning based language model 780. The response is generated by the machine learning based language model 780 by processing a prompt comprising text describing the sequence of user interactions and instructions to generate the summary of the session replay from the sequence of user interactions.

According to an embodiment, the replay clustering module 730 extracts description of user interactions of the session replay from a response generated by a machine learning based language model by processing a prompt comprising the DOM representation of the user interaction.

FIG. 9 shows a flowchart illustrating the process of generating descriptions of clusters of session replays according to an embodiment. The steps of the process illustrated in FIG. 9 may be performed by various modules of the replay analysis module 265 for example, the cluster labeling module 740 and the AI analysis presentation module 760.

According to an embodiment, the cluster labeling module 740 receives 910 a cluster of session replays for labelling. The cluster labeling module 740 determines 920 features representing characteristics of the cluster of session replays. According to an embodiment, the cluster labeling module 740 stores a representation of expected features of sessions, for example, typical user interactions expected in a session based on a particular feature of a website or an online system being released, typical delay between user interactions, typical subsequences of user interactions expected in the sessions, and so on. The expected features may be determined based on an analysis of all the sessions received, for example, aggregate values for features. Alternatively, the expected features may be received from a user, for example, an expert user. The cluster labeling module 740 determines typical features of a cluster by comparing features of the cluster with expected features of the sessions. The cluster labeling module 740 identifies features representing the cluster as features that significantly deviate from the corresponding expected feature values. A feature significantly deviates from the corresponding expected feature values if the feature value for the cluster is different from the expected feature value by more than a threshold amount or by more than a threshold factor.

The cluster labeling module 740 repeats step 930 for each feature of the cluster. Accordingly, the cluster labeling module 740 determines 930 a score ranking the feature as a characteristic of the cluster. For example, the score may be determined based on a degree (or factor) by which the feature is different from a corresponding expected feature value. The cluster labeling module 740 ranks 940 the features describing the cluster based on their scores. The cluster labeling module 740 selects 950 top few features of the cluster based on the ranking. The cluster labeling module 740 generates 960 a label for the cluster based on the selected top few features. For example, the 740 may select 950 the top feature based on the ranking and use that feature to generate 960 a label for the cluster.

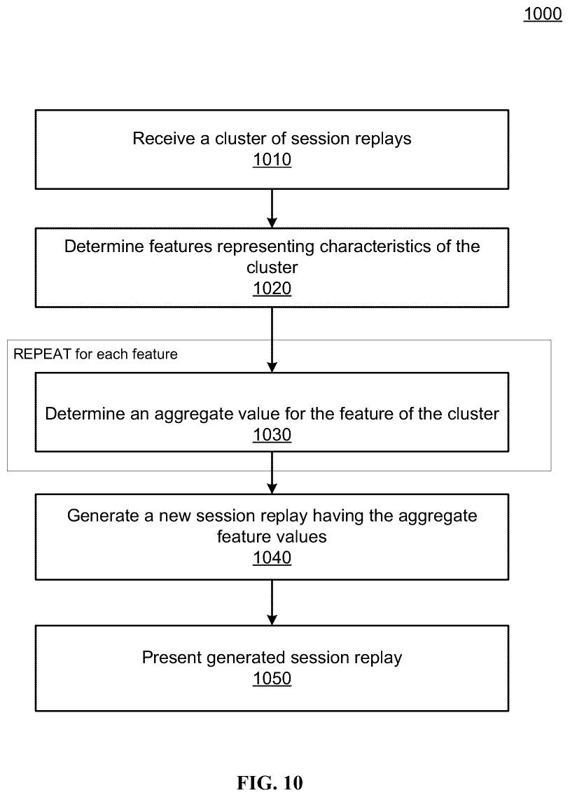

FIG. 10 shows a flowchart illustrating the process of generating a representative session replay for a cluster of session replays according to an embodiment. The steps of the process illustrated in FIG. 10 may be performed by various modules of the replay analysis module 265 for example, the replay generation module 750 and the AI analysis presentation module 760.

The replay generation module 750 receives 1010 a cluster of session replays for generating a representative replay for the cluster. The replay generation module 750 determines 1020 features representing characteristics of the cluster, for example, as described above for the process illustrated in FIG. 9. The replay generation module 750 repeats step 1030 for each feature. Accordingly, for each feature the replay generation module 750 determines an aggregate value for the feature. The aggregate value is determined by aggregating the feature across all sessions of the cluster. The aggregate value may be an average value, a median value, or any other metric representing an aggregate. The replay generation module 750 generates a new session having the aggregate feature values. For example, if the aggregate feature represents an above average delay between user interactions, the replay generation module 750 assigns delays between user interactions to obtain the above average delay. The replay generation module 750 provides the generated session to the replay generation module 750 for presentation, for example, via a user interface.

### User Interfaces

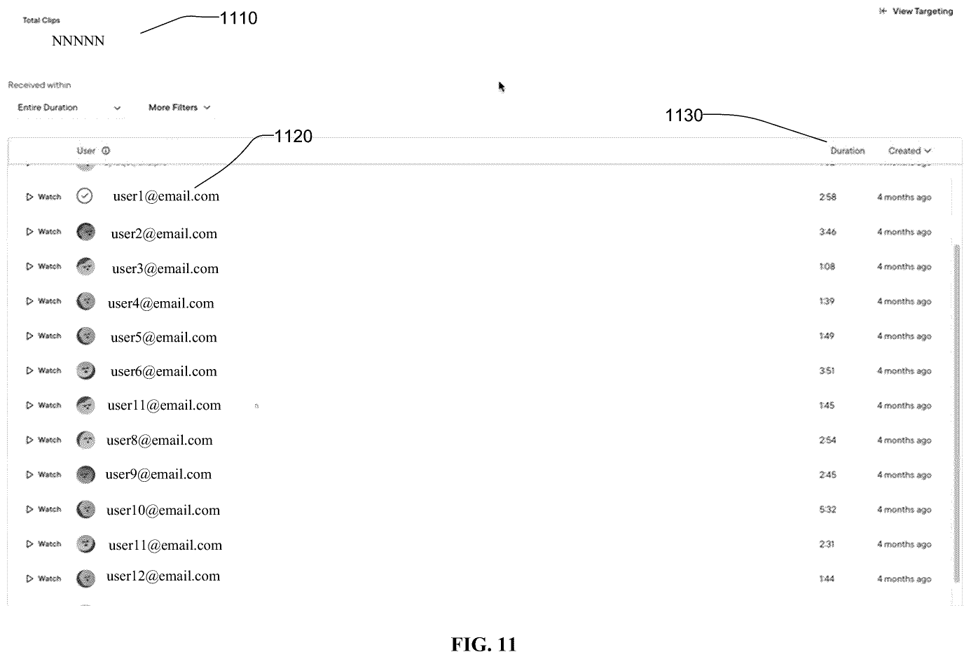

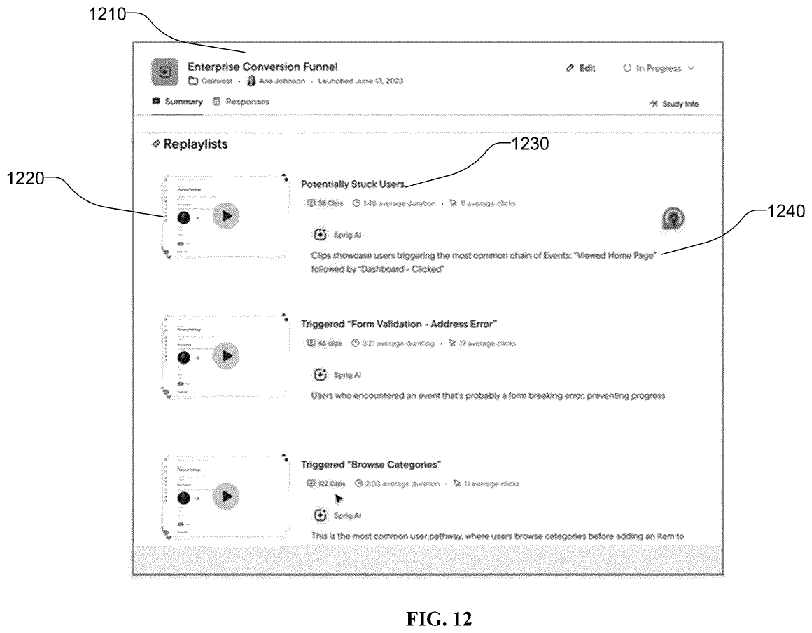

FIGS. 11 and 12 illustrates screenshots of user interfaces that may be generated by AI analysis presentation module 760 for presenting to the user. The user interfaces described are exemplary and a person skilled in the art would understand that other types of user interfaces and layouts can be user instead.

FIG. 11 shows a screenshot of a user interface illustrating session replay data received by the system according to an embodiment. The system may receive a large number of sessions. The user interface shown in FIG. 11 displays user identifiers 1120, for example, emails or names of users that provided the session replays and information describing each session replay, for example, duration 1130 of each session. The user interface may also display the total number 1110 of session replays received for a particular feature. A user may play a specific session received from a user.

FIG. 12 shows a screenshot of a user interface illustrating clusters of session replays presented by the system according to an embodiment. The user interface shows multiple clusters 1220 of session replays generated for sessions replays received for a feature 1210, for example, by executing the process illustrated in FIG. 8. For each cluster the user interface further shows metadata generated by the cluster labeling module 740, for example, the label 1230 and a description 1240 for each cluster as generated by the process illustrated in FIG. 9. The user interface may further allow a user to play a session replay generated for the cluster by the replay generation module 750, for example, a session replay generated by the process illustrated in FIG. 10.

### Additional Considerations

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving a plurality of session replays, each session replay representing a sequence of user interactions performed with a user interface of an online application, the sequence of user interactions performed within a time interval;
for each of the plurality of session replays, generating a representation of the session replay;
clustering the plurality of session replays using representations of the plurality of session replays to obtain a plurality of clusters of session replays, wherein a cluster of session replays comprises session replays determined to be similar to other session replays of the cluster of session replays;
for each cluster of session replay from the plurality of clusters of session replays, determining information characterizing the cluster of session replays;
selecting at least a subset of clusters of session replays from the plurality of clusters of session replays; and
sending information characterizing each cluster of session replays from the subset of clusters of session replays for display via a user interface.

2. The method of claim 1, wherein each session replay is associated with trigger events of a trigger event type, wherein the session replay is generated responsive to detecting an occurrence of a trigger event of the trigger event type and extracting session replay data representing user actions performed with the online application via the user interface within a temporal neighborhood of the trigger event.

3. The method of claim 1, wherein generating the representation of the session replay comprises:
generating a vector embedding based on the session replay, wherein clustering the session replays is performed based on vector distances between vector embedding representations of the plurality of session replays.

4. The method of claim 3, wherein generating the representation of the session replay comprises:
generating a feature vector representing the session replay, the feature vector comprising, the feature vector for a session replay for a session comprising one or more of:
number of clicks in the session,
total replay time of the session, or
time spent by the user on one or more pages during the session;
providing the feature vector as input to a machine learning model; and
extracting a vector embedding from the machine learning model.

5. The method of claim 3, wherein generating the vector embedding based on the session replay comprises:
generating a prompt for a machine learning based language model, the prompt comprising a text representation of the session replay;
providing the prompt to the machine learning based language model; and
extracting the vector embedding from a response received from the machine learning based language model.

6. The method of claim 1, wherein generating the representation of the session replay comprises:
for each user interaction from the sequence of user interactions of the session replay, generating text describing the user interaction.

7. The method of claim 6, wherein generating the representation of the session replay comprises:
extracting a summary of the session replay from a response generated by a machine learning based language model by processing a prompt comprising text describing the sequence of user interactions and instructions to generate the summary of the session replay from the sequence of user interactions.

8. The method of claim 6, wherein a user interaction of the session replay comprises a document object model (DOM) representation of a web page of the online application, the method further comprising:
extracting description of one or more user interactions of the session replay from a response generated by a machine learning based language model by processing a prompt comprising the DOM representation of the user interaction.

9. The method of claim 1, wherein the information characterizing the cluster of session replays comprises:
a video illustrating user interactions representing the cluster of session replays, the video generated from user interactions having high likelihood of occurrence in the session replays of the cluster of session replays.

10. The method of claim 1, wherein the information characterizing the cluster of session replays comprises:
statistics indicative of average session time of session replays of the cluster of session replays.

11. A non-transitory computer-readable storage medium comprising instructions which, when executed by one or more processors, cause the one or more processors to perform steps comprising:
receiving a plurality of session replays, each session replay representing a sequence of user interactions performed with a user interface of an online application, the sequence of user interactions performed within a time interval;
for each of the plurality of session replays, generating a representation of the session replay;
clustering the plurality of session replays using representations of the plurality of session replays to obtain a plurality of clusters of session replays, wherein a cluster of session replays comprises session replays determined to be similar to other session replays of the cluster of session replays;
for each cluster of session replay from the plurality of clusters of session replays, determining information characterizing the cluster of session replays;
selecting at least a subset of clusters of session replays from the plurality of clusters of session replays; and
sending information characterizing each cluster of session replays from the subset of clusters of session replays for display via a user interface.

12. The non-transitory computer-readable storage medium of claim 11, wherein each session replay is associated with trigger events of a trigger event type, wherein the session replay is generated responsive to detecting an occurrence of a trigger event of the trigger event type and extracting session replay data representing user actions performed with the online application via the user interface within a temporal neighborhood of the trigger event.

13. The non-transitory computer-readable storage medium of claim 11, wherein generating the representation of the session replay comprises:
generating a vector embedding based on the session replay, wherein clustering the session replays is performed based on vector distances between vector embedding representations of the plurality of session replays.

14. The non-transitory computer-readable storage medium of claim 13, wherein generating the representation of the session replay comprises:
generating a feature vector representing the session replay, the feature vector comprising, the feature vector for a session replay for a session comprising one or more of:
number of clicks in the session,
total replay time of the session, or
time spent by the user on one or more pages during the session;
providing the feature vector as input to a machine learning model; and
extracting a vector embedding from the machine learning model.

15. The non-transitory computer-readable storage medium of claim 13, wherein generating the vector embedding based on the session replay comprises:
generating a prompt for a machine learning based language model, the prompt comprising a text representation of the session replay;
providing the prompt to the machine learning based language model; and
extracting the vector embedding from a response received from the machine learning based language model.

16. The non-transitory computer-readable storage medium of claim 11, wherein generating the representation of the session replay comprises:
for each user interaction from the sequence of user interactions of the session replay, generating text describing the user interaction.

17. The non-transitory computer-readable storage medium of claim 16, wherein generating the representation of the session replay comprises:
extracting a summary of the session replay from a response generated by a machine learning based language model by processing a prompt comprising text describing the sequence of user interactions and instructions to generate the summary of the session replay from the sequence of user interactions.

18. The non-transitory computer-readable storage medium of claim 16, wherein a user interaction of the session replay comprises a document object model (DOM) representation of a web page of the online application, the method further comprising:
extracting description of one or more user interactions of the session replay from a response generated by a machine learning based language model by processing a prompt comprising the DOM representation of the user interaction.

19. The non-transitory computer-readable storage medium of claim 11, wherein the information characterizing the cluster of session replays comprises:
a video illustrating user interactions representing the cluster of session replays, the video generated from user interactions having high likelihood of occurrence in the session replays of the cluster of session replays.

20. A system comprising one or more processors and a non-transitory computer-readable storage medium storing instructions that when executed by the one or more processors, cause the one or more processors to perform steps comprising:
receiving a plurality of session replays, each session replay representing a sequence of user interactions performed with a user interface of an online application, the sequence of user interactions performed within a time interval;
for each of the plurality of session replays, generating a representation of the session replay;
clustering the plurality of session replays using representations of the plurality of session replays to obtain a plurality of clusters of session replays, wherein a cluster of session replays comprises session replays determined to be similar to other session replays of the cluster of session replays;
for each cluster of session replay from the plurality of clusters of session replays, determining information characterizing the cluster of session replays;
selecting at least a subset of clusters of session replays from the plurality of clusters of session replays; and
sending information characterizing each cluster of session replays from the subset of clusters of session replays for display via a user interface.
